(19) United States
(12) Patent Application Publication
(10) Pub. No.: US 2003/0066595 A1
(43) Pub. Date: Apr. 10, 2003

(54) Method for making a shoe

(76) Inventor: Cheng-Hsian Chi, Taichung City (TW)

Correspondence Address: LADAS & PARRY, 26 West 61st Street, New York, NY, 10023-7604, US

(21) Appl. No.: 09/973,575

(22) Filed: Oct. 9, 2001

(51) Int. Cl. B29B 7/00; B29C 47/00

(52) U.S. Cl. 156/245; 156/242

(57) ABSTRACT

A method for making a shoe includes the steps of preparing an outsole, a foamed insole blank and an upper, preparing a mold that has an upper mold part with a last having an upper heating passage, a bottom mold part having a bottom heating passage, and two opposite side mold parts each having a side heating passage; applying an adhesive layer to the outsole and a peripheral bottom edge of the upper; placing the outsole, the insole blank and the upper into the mold; thermally molding assembly of the outsole, the insole blank, and the upper by passing a heating medium through the upper, bottom and side heating passages, and cooling the mold by passing a cooling medium through the heating passages after molding.

### BACKGROUND OF THE INVENTION

1. Field of the Invention

The invention relates to a method for making a shoe, more particularly to a method for making a shoe in which an insole blank of the shoe can be assembled with an outsole and an upper of the shoe by directly thermal-molding without preheating of the inside blank.

2. Description of the Related Art

U.S. Pat. No. 4,960,374 relates to an apparatus for molding outer and inner soles and a sole welt on to shoe uppers. A molded outer sole is formed by injection molding plasticized thermoplastic material into a first mold cavity. A molded sole welt is formed on a last supported shoe upper by injection molding plasticized thermoplastic material into a sole welt mold cavity. A molded inner sole is formed by injection molding foamed plasticized thermoplastic material into an inner sole mold cavity. However, the injection molding technique involves a complicated mold venting system, and is susceptible to problems relating to the molding pressure applied to the mold, and the molding temperature.

U.S. Pat. No. 5,560,877 discloses a process for manufacturing an ethylene vinyl acetate (EVA) sole that involves weighing molding compounds for manufacturing the sole. The molded compounds are mixed, and extruded by means of a twin screw extruder so as to form a web of unfoamed extruded output. The web is cut into sheets. At least one of the sheets is placed into a first mold unit, which is heated and pressurized so as to form a rough foamed sole. The rough foamed sole is placed into a second mold unit, which is heated, pressurized, and cooled so as to form an embossed sole with a predeterminated pattern. As two different mold units are required to make the embossed sole, and it is necessary to further adhere the embossed sole to an upper and an outsole of a shoe, this process is complicated and troublesome.

U.S. Pat. No. 4,266,314 discloses a method for manufacturing sports shoes. At least two overlapping portions of plastic material are overmolded successively on a lining formed by a slipper so as to cover the slipper sole and upper at least to a partial extent. The method includes the steps of: overmolding a plastic layer which covers the entire upper of the slipper, overmolding a plastic stiffening reinforcement having greater rigidity than the previous layer and constituting a shell around the rear counter as well as a thin intermediate sole, and adding an outer wearing sole of molded plastic material to the outer surface of the thin intermediate sole.

FIG. 1 illustrates a conventional method for preparing a sole with diverse colors and materials, which includes the steps of: arranging a plurality of blocks 101, 102, 103 with predetermined shapes and colors to form an insole blank 1, disposing the insole blank 1 and an outsole 2 into a mold, and then thermally pressing the mold to obtain the sole. However, it will be difficult to place the blocks 101, 102, 103 into the mold for thermal molding if they are preheated to a high temperature.

### SUMMARY OF THE INVENTION

Therefore, the object of the present invention is to provide a method for making a shoe integrally, in which an insole blank of the shoe is disposed into a mold together with an outsole and an upper of the shoe at ambient temperature, and then is assembled integrally into a shoe by thermal molding.

Accordingly, the method for making a shoe includes the steps of: preparing an outsole; preparing a foamed insole blank that has a peripheral edge and that is to be disposed over the outsole; preparing an upper that has a bottom which is to be disposed over the insole blank and which has a geometric dimension smaller than that of the peripheral edge of the insole blank, and a peripheral bottom edge which extends upwardly from a periphery of the bottom of the upper; preparing a mold that defines a mold cavity, and that has an upper mold part with a last which is formed with an upper heating passage, a bottom mold part opposite to the upper mold part and formed with a bottom heating passage, and two opposite side mold parts formed with a side heating passage; applying an adhesive layer to the outsole and the peripheral bottom edge of the upper; placing the outsole, the insole blank and the upper in the mold cavity at ambient temperature such that the outsole is mounted on the bottom mold part, such that the upper is fittingly sleeved on the last, and such that the insole blank is sandwiched between the adhesive layer on the outsole and the bottom of the upper, with the peripheral edge of the insole blank being sandwiched between the side mold parts and the adhesive layer on the peripheral bottom edge of the upper; closing the mold; thermally molding assembly of the outsole, the insole blank, and the upper by passing a heating medium through the upper, bottom and side heating passages; and cooling the mold by passing a cooling medium through the upper, bottom and side heating passages after molding.

### BRIEF DESCRIPTION OF THE DRAWINGS

Other features and advantages of the present invention will become apparent in the following detailed description of the preferred embodiments with reference to the accompanying drawings, of which:

FIG. 1 is an exploded perspective view of a conventional sole component;

FIGS. 2 and 3 illustrate how a shoe is made by the method according to this invention;

FIG. 4 is a fragmentary schematic view illustrating an inflatable member which can be optionally placed between the insole blank and the bottom of the upper in the mold;

FIGS. 5 and 6 illustrate how a shoe with a cover strip is made by the method according to this invention;

FIG. 7 illustrates how a sandal is made according to the method of this invention;

FIGS. 8 to 11 illustrate another way of making a sandal according to the method of this invention; and

FIG. 12 illustrates how a shoe with a simple configuration is made by the method according to this invention.

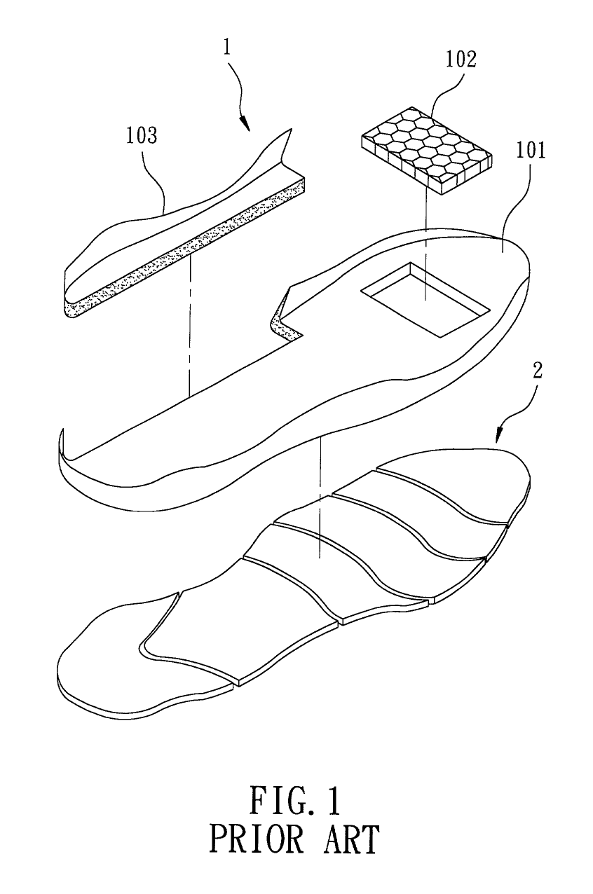

### DETAILED DESCRIPTION OF THE PREFERRED EMBODIMENTS

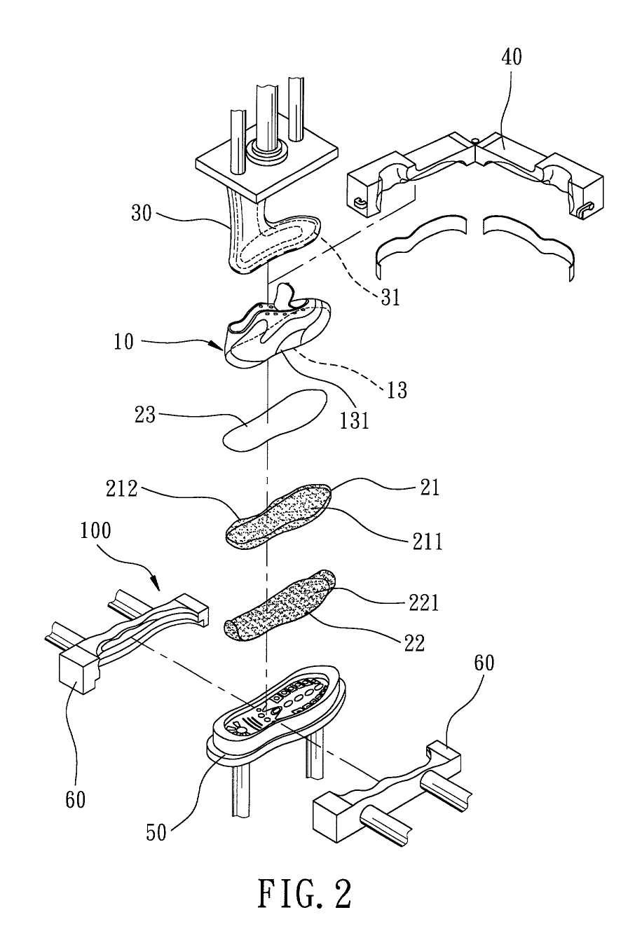

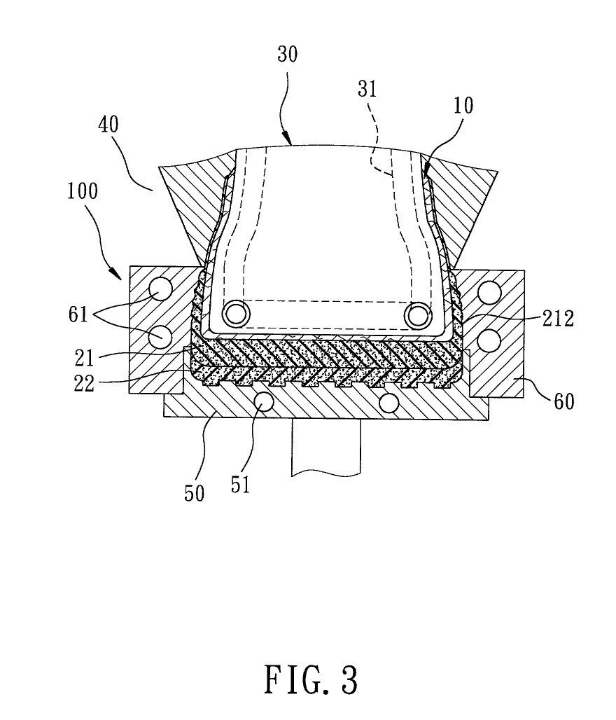

Referring to FIGS. 2 and 3, the preferred embodiment of the process for making a shoe according to this invention comprises the steps of:

(1) Preparing an outsole 22:

The outsole 22 is formed in advance.

(2) Preparing a foamed insole blank 21:

The foamed insole blank 21 is formed of ethylene vinyl acetate (EVA) copolymer, and has a top surface 211 and a peripheral edge 212 extending upward from a periphery of the top surface 211. The foamed insole blank 21 is to be disposed over the outsole 22.

(3) Preparing an upper 10:

The upper 10 has a bottom 13 which is to be disposed over the insole blank 21 and which has a geometric dimension smaller than that of the peripheral edge 212 of the insole blank 21, and a peripheral bottom edge 131 which extends upwardly from a periphery of the bottom 13 of the upper 10.

(4) Preparing a mold 100:

The mold 100 defines a mold cavity, and has an upper mold part 40 with a last 30 which is formed with an upper heating passage 31, a bottom mold part 50 opposite to the upper mold part 40 and formed with a bottom heating passage 511 and two opposite side mold parts 60 each of which is formed with a side heating passage 61.

(5) Applying an adhesive layer to the outsole 22 and the peripheral bottom edge 131 of the upper 10:

The top surface 221 of the outsole 22 and the peripheral bottom edge 131 of the upper 10 are applied with an adhesive layer. Additionally, a thermal-setting adhesive film 23 is placed between the insole blank 21 and the bottom 13 of the upper 10. The peripheral edge 212 of the insole blank 21 is to be adhered to the peripheral bottom edge 131 of the upper 10.

(6) Placing the outsole 22, the adhesive film 23, the insole blank 21, and the upper 10 in the mold cavity at the ambient temperature:

The outsole 22, the insole blank 21 and the upper 10 are placed in the mold cavity at the ambient temperature such that the outsole 22 is mounted on the bottom mold part 50, such that the upper 10 is fittingly sleeved on the last 30, and such that the insole blank 21 is sandwiched between the adhesive film 23 on the outsole 22 and the bottom 13 of the upper 10, with the peripheral edge 212 of the insole blank 21 being sandwiched between the side mold parts 60 and the adhesive layer on the peripheral bottom edge 131 of the upper 10.

(7) Closing the mold:

(8) Thermally molding assembly of the outsole 22, the insole blank 21, and the upper 10:

Thermally molding assembly of the outsole 22, the insole blank 21, and the upper 10 is carried out by passing a heating medium through the upper, bottom and side heating passages 31, 51, 61. The heating medium that passes through the bottom and side heating passages 51, 61 is provided by a heating device (not shown). Heat is transmitted from the bottom mold part 50 and the side mold parts 60 to the insole blank 21 and the outsole 22 so as to adhere the insole blank 21 to the outsole 22. Simultaneously, the heat created by the heating medium passing through the upper heating passages 31 is transmitted to the thermal-setting adhesive film 23 through the bottom 13 of the upper 10 so as to melt the thermal-setting adhesive film 23 and to adhere the upper 10 to the insole blank 21. Therefore, the upper 10, the insole blank 21 and the outsole 22 are assembled integrally by thermal molding. Preferably, the molding time ranges from 1 to 7 minutes, and the molding temperature ranges from 100 to 150° C.

(8) Cooling the mold 100:

After molding, the supply of the heating medium is terminated, and the mold 100 is subsequently cooled by passing a cooling medium through the upper, bottom and side heating passages 31, 51, 61.

(9) opening the mold:

The mold is opened after the cooling process. The shoe thus produced is trimmed to obtain a final shoe product. The upper, bottom and side heating passages 31, 51, 61 are preheated once again by supplying the heating medium from the heating device for the next processing.

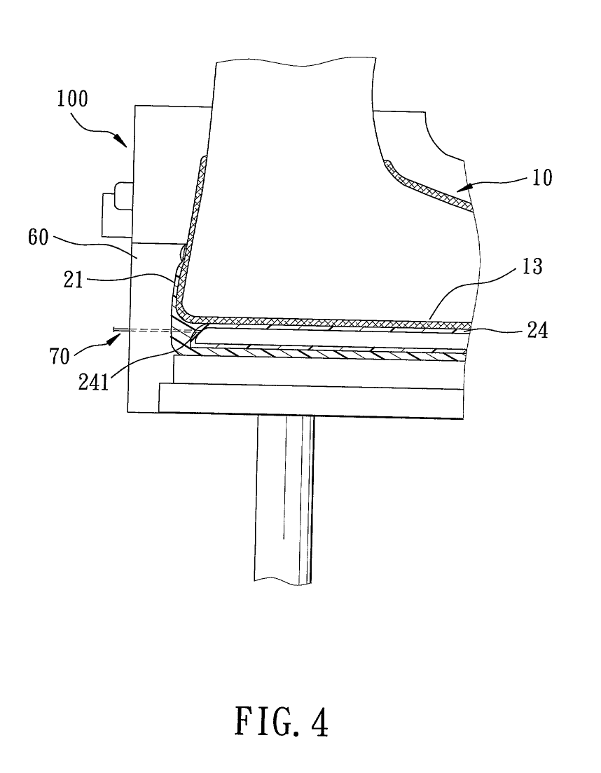

Referring to FIG. 4, an inflatable member 24 is optionally placed between the insole blank 21 and the bottom 13 of the upper 10 in the mold 100 before molding. The inflatable member 24 is provided with a hole 241 for inserting a gas providing unit 70 therein. Hot gas can be transported into the inflatable member 24 through the gas providing unit 70 to heat the insole blank 21 indirectly and to expand the insole blank 21 against the side mold parts 60.

Alternatively, as shown in FIG. 4, the upper 10 and the insole blank 21 can be first assembled by thermal molding according to the method of this invention. The assembly thus formed is then adhered to the outsole 22 so as to enhance the wearing-resistant effect.

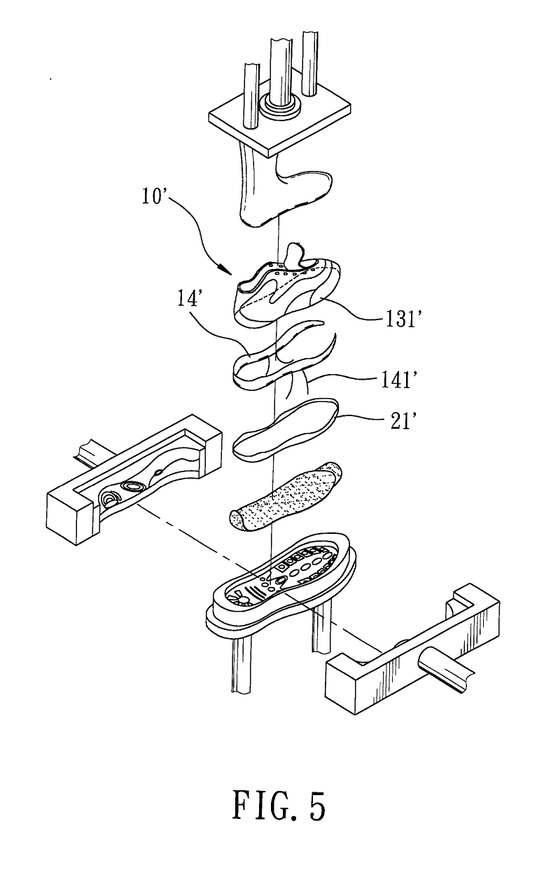

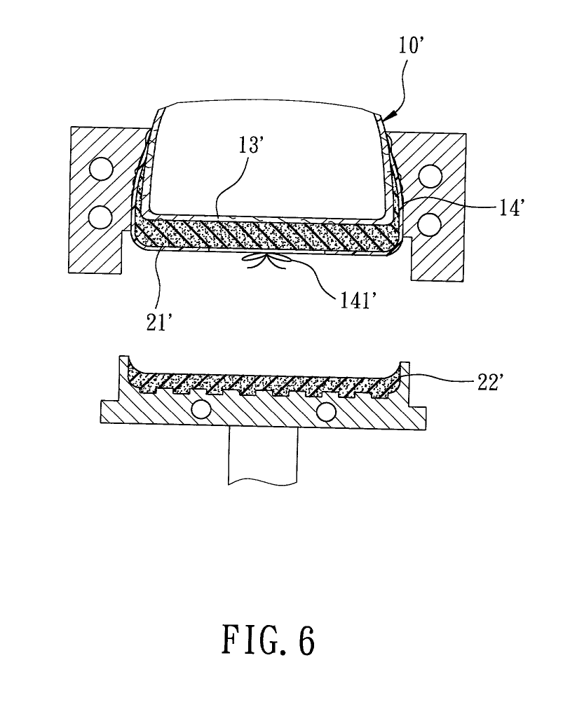

FIGS. 5 and 6 illustrate how a shoe with a cover strip is made by the method according to this invention. The shoe is similar to that shown in FIGS. 2 and 3, except that a cover strip 14′ is attached to the peripheral edge 131′ of the upper 10′ by stitching or adhering. The cover strip 14′ can be made of material such as PVC, EVA, PU, plasticor leather. Additionally, tying threads 141′ are provided along the peripheral edge of the cover strip 14′ for tying the upper 10′ and the insole blank 21′ together before molding.

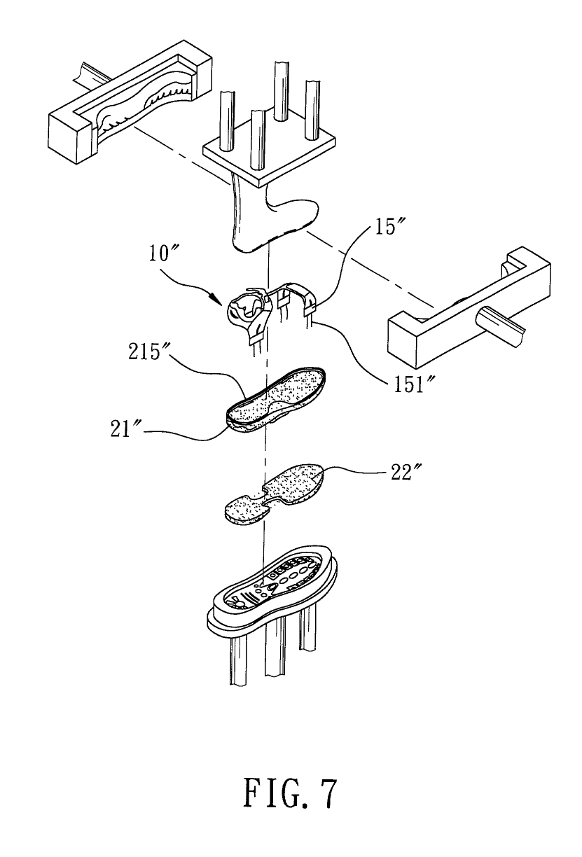

FIG. 7 illustrates how a sandal is made according to the method of this invention. The sandal includes an outsole 22″, an insole blank 21″ disposed over the outsole 22′, and a strap unit 10″ having four end portion 15″. Each of the end portions 15″ of the strap unit 10″ first passes through a corresponding one of slits 215″ formed in the insole blank 21″, and is then connected to the outsole 22″ by stitching or by tying threads 151″ provided at each of the end portions 15″ of the strap unit 10″. The molds are subsequently closed, and the thermal molding proceed as described herein above is carried out to make the sandal.

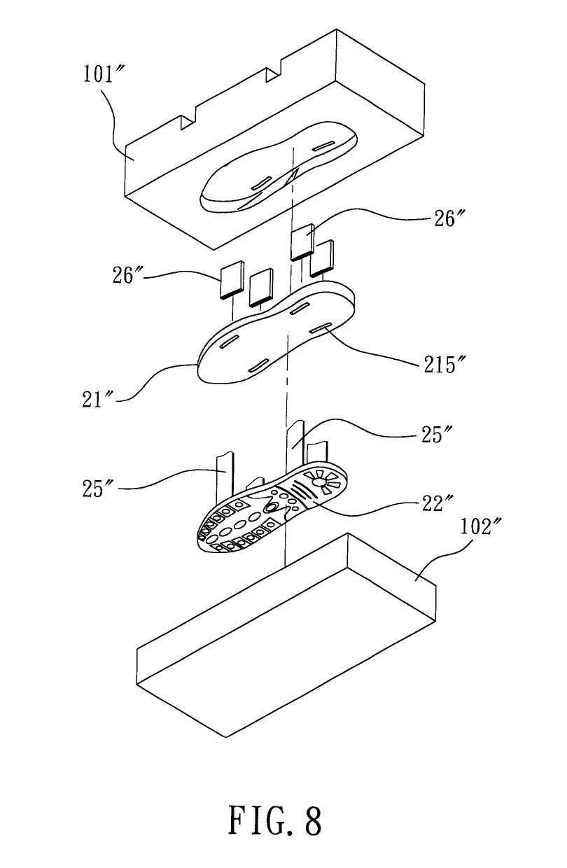

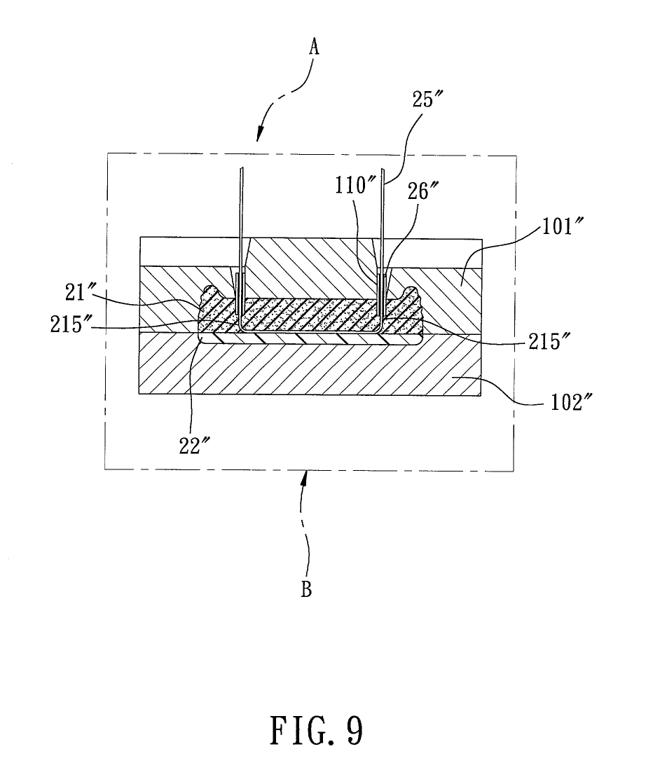

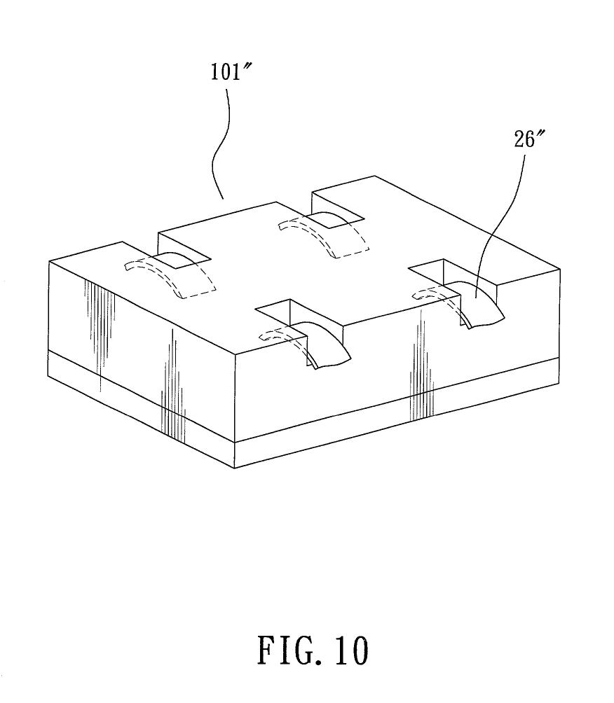

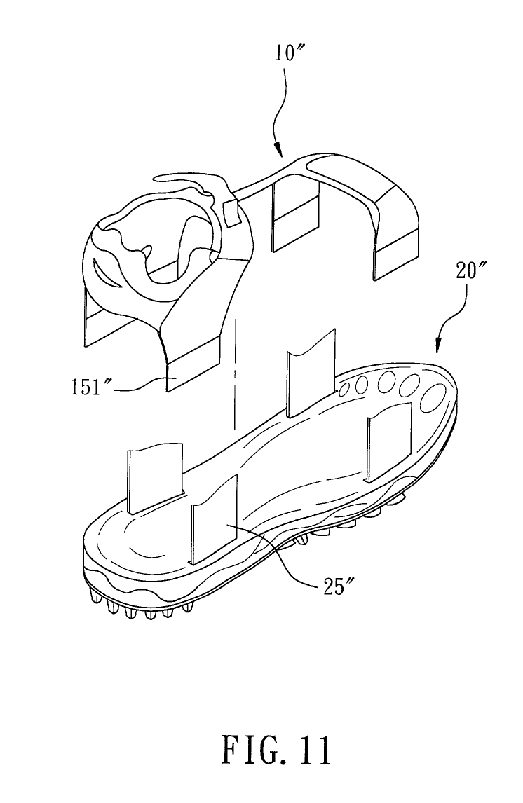

Referring to FIGS. 8 to 11, which illustrate another way of making a sandal according to the method of this invention, the outsole 22″ is provided with a pair of linking straps 25″. The insole blank 21″ is formed with four slits 215″ for passage of end portions of the linking straps 25″. Four positioning sleeves 26″ are disposed such that the four positioning sleeves 26″ extend through the upper mold part 101″ and respectively into the slits 215″, and such that the end portions of the linking straps 25″ extend through the positioning sleeves 26″ and the upper mold part 101″. The positioning sleeves 26″ are made of a material which is flexible and resistant to high temperature. The insole blank 21″ and the outsole 22″ are respectively mounted into the upper mold part 101″ and the bottom mold part 102″. Referring to FIG. 10, portions of the positioning sleeves 26″ that are exposed from the upper mold part 101″ are bent in order to be anchored on the upper mold part 101″. The upper mold part 101″ and the bottom mold part 102″ are then closed, and thermal molding is proceeded after enclosing the upper and bottom mold parts 101″, 102″ with complementary upper and lower heating devices (A, B), as shown in FIG. 9, After molding, the positioning sleeves 26″ can be removed, and the end portions of the linking straps 25″ can be stitched onto the end portions 151″ of the strap unit 10″ to thereby form a sandal product.

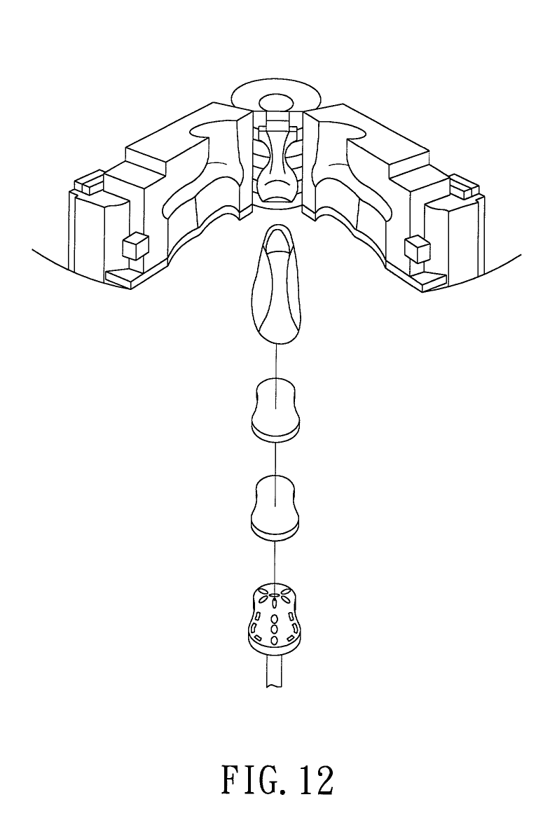

Referring to FIG. 12, the method according to this invention can be used for making a shoe with a relatively simple configuration.

In the present invention, since the insole blank 21, 21′, 21″ is placed into the mold at ambient temperature, the aforesaid drawbacks as encountered in the prior art can be eliminated.

While the present invention has been described in connection with what is considered the most practical and preferred embodiments, it is understood that this invention is not limited to the disclosed embodiments but is intended to cover various arrangements included within the spirit and scope of the broadest interpretation so as to encompass all such modifications and equivalent arrangements.

I claim:

1. A method for making a shoe, comprising the steps of:
preparing an outsole;
preparing a foamed insole blank that has a peripheral edge and that is to be disposed over said outsole;
preparing an upper that has a bottom which is to be disposed over said insole blank and which has a geometric dimension smaller than that of said peripheral edge of said insole blank, and a peripheral bottom edge which extends upwardly from a periphery of said bottom of said upper;
preparing a mold that defines a mold cavity, and that has an upper mold part with a last which is formed with an upper heating passage, a bottom mold part opposite to said upper mold part and formed with a bottom heating passage, and two opposite side mold parts each of which is formed with a side heating passage;
applying an adhesive layer to said outsole and said peripheral bottom edge of said upper;
placing said outsole, said insole blank and said upper in said mold cavity at ambient temperature such that said outsole is mounted on said bottom mold part, such that said upper is fittingly sleeved on said last, and such that said insole blank is sandwiched between said adhesive layer on said outsole and said bottom of said upper, with said peripheral edge of said insole blank being sandwiched between said side mold parts and said adhesive layer on said peripheral bottom edge of said upper;
closing said mold;
thermally molding assembly of said outsole, said insole blank, and said upper by passing a heating medium through said upper, bottom and side heating passages; and
cooling said mold by passing a cooling medium through said upper, bottom and side heating passages after molding.

2. The method of claim 1, further comprising the step of placing an inflatable member between said insole blank and said bottom of said upper in said mold before molding, and the step of inflating said inflatable member so as to expand said insole blank against said side mold parts.

3. The method of claim 1, further comprising the step of placing a thermal-setting adhesive between said insole blank and said bottom of said upper in said mold before molding.
